(19) United States
(12) Patent Application Publication
(10) Pub. No.: US 2009/0327072 A1
(43) Pub. Date: Dec. 31, 2009

(54) PRESENTATION OF SEQUENTIAL ADVERTISEMENTS

(75) Inventor: Mehul Sanghavi, Sunnyvale, CA (US)

Correspondence Address: BEYER LAW GROUP LLP/YAHOO, PO BOX 1687, CUPERTINO, CA, 95015-1687, US

(73) Assignee: YAHOO! INC., Sunnyvale, CA (US)

(21) Appl. No.: 12/146,296

(22) Filed: Jun. 25, 2008

(51) Int. Cl. G06Q 30/00; G06Q 10/00

(52) U.S. Cl. 705/14.49

(57) ABSTRACT

Advertisements are provided to a user. An initial advertisement is provided to a user, where the initial advertisement is a first advertisement of a series of related advertisements from a same advertiser. Subsequent advertisements of the series are provided to the user based on a demonstrated intent from the user to view the subsequent advertisements while the user is viewing advertisements of the series. A cost per completion amount is determined based on the progression of the user within the series of advertisements.

### TECHNICAL FIELD

The present invention is in the field of presenting display advertisements based on online activity and, in particular, is directed to displaying advertisement sequences based on a user's demonstrated intent to view subsequent advertisements in a sequence.

### BACKGROUND

Many web-based advertisements are placed by a web publisher on a “per-property” basis, such as different web properties that are unified by a web portal. For example, a decision whether to place an advertisement on a particular web page may be based on whether a user is viewing a web page that is an “e-mail” page, a “finance” page, a “portal front page,” etc. In addition, while many advertisements may be provided based on demographic considerations of a particular user, it is still difficult to match an advertisement to a user's interests. Therefore, for these and other reasons, many advertisements are displayed, on web pages being viewed, to users who do not have interest in the advertisements.

Furthermore, from a user's point of view in such an environment, there is no predictable way for the user to see advertisements from the same advertiser. In addition, it can be a nuisance to the user to be presented with advertisements in which he has no interest. From the publisher's point of view, it is undesirable to use valuable screen real estate to display an advertisement with which a user has no interest, since the publisher can gain greater monetary benefit by displaying advertisements in which a user has an interest.

### SUMMARY

In accordance with one example, advertisements are provided to a user. An initial advertisement is provided to a user, where the initial advertisement is a first advertisement of a series of related advertisements from a same advertiser. Subsequent advertisements of the series are provided to the user based on a demonstrated intent from the user to view the subsequent advertisements while the user is viewing advertisements of the series. A cost per completion amount is determined based on the progression of the user within the series of advertisements.

### BRIEF DESCRIPTION OF FIGURES

FIG. 1 is a flowchart illustrating a method in accordance with a broad aspect of the invention, in which a cost per completion amount is determined based on an amount of progression by a viewer within a sequence of advertisements.

FIG. 2 schematically illustrates example advertisement displays of various sequences of advertisements.

FIG. 3 illustrates an example in which a user state, with respect to viewing displayed advertisement sequences, is persisted even after a user exits a website/property.

FIG. 4 schematically illustrates an example of a system in which the FIG. 1 method may be provided.

FIGS. 5a, 5b and 5c illustrate various Cost Per Completion functions.

FIG. 6 is a simplified diagram of a network environment in which specific embodiments of the present invention may be implemented.

### DETAILED DESCRIPTION

In accordance with one aspect, a system and/or method is provided in which an advertiser provides a sequence of advertisements for display to a user who is viewing web pages. The viewed web pages may be, for example, web pages of a web property such as a portal. The advertisements are provided to the user's computer via a network connection. The sequence of advertisements is such that, after the first advertisement is displayed, subsequent advertisements in the sequence may be displayed based on a demonstrated user intent to view the subsequent advertisements, while the user is viewing advertisements of the series. A cost per completion amount (which may roughly correspond to an amount of revenue that the publisher may garner based on publishing of the advertisements) may be based on an amount of progression of the user within the series of advertisements.

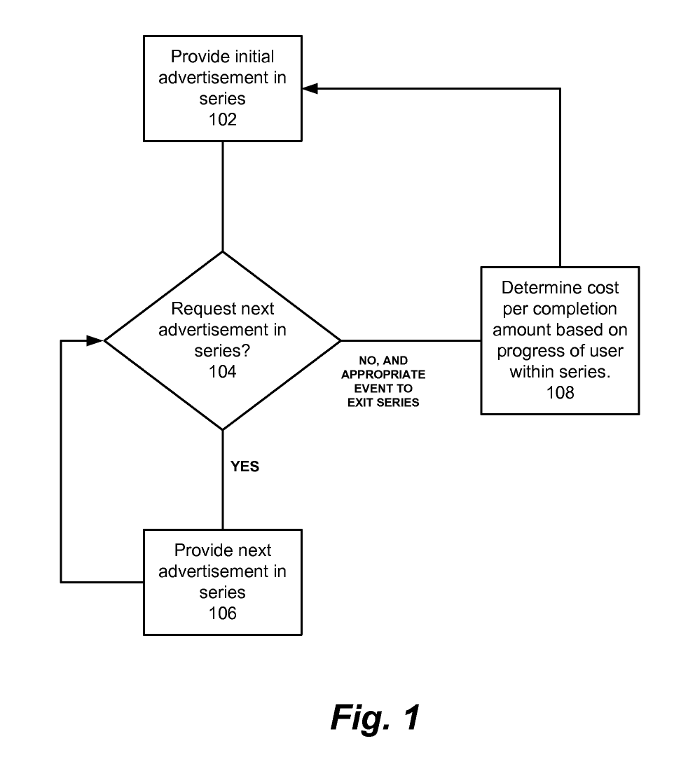

FIG. 1 is a flowchart illustrating a method in accordance with a broad aspect of the invention. At 102, an initial advertisement in a series is caused to be displayed. The first advertisement of a series may be displayed, for example, based on a combination of a user's demographic/behavioral/geo-location data. In general, the first advertisement of a series will generally not be displayed based on a user's specific intent for the advertisement to be displayed although this is possible in some examples. The advertisement being displayed may be, for example, a typical display advertisement such as may be displayed in a predetermined portion of a web page. However, the display advertisement are not necessarily limited to advertisement that are displayed in a predetermined portion of a web page but may, for example, include other types of display such as “pop-up windows,” floating advertisements or other types of display which do or do not partially or completely obstruct the web page content.

At 104, it is determined if a next advertisement in the series is requested to be displayed. Examples are discussed later of how a next advertisement in the series may be requested to be displayed. If a next advertisement in the series is requested to be displayed then, at 106, a subsequent advertisement in the series is displayed. Otherwise, at a time another advertisement would be displayed (such as, for example, moving to another web page or requesting a page refresh), the advertisement series is exited, such that, when it is appropriate to cause an advertisement to be displayed, an advertisement not in the series is caused to be displayed.

At 108, a cost per completion amount is determined for the series of advertisements based on a function of progression of the user within the series of advertisements. Thus, for example, in accordance with one cost per completion determination scheme, the further along in a series a user progresses, the greater the publisher's revenue based on display of the advertisement sequence. This function of progress may be, for example, “all or nothing” such that there is no cost to the advertiser unless the series is completed. As another example, the cost may increase linearly or by some other function, such as exponentially, based on the progression of the user within the series.

In this way, the user can be presented with advertisements in which the user has a demonstrated interest. From the publisher's point of view, valuable screen real estate is used to display advertisements with which the user has interest, and the publisher can gain greater monetary benefit by displaying such advertisements in which a user has an interest.

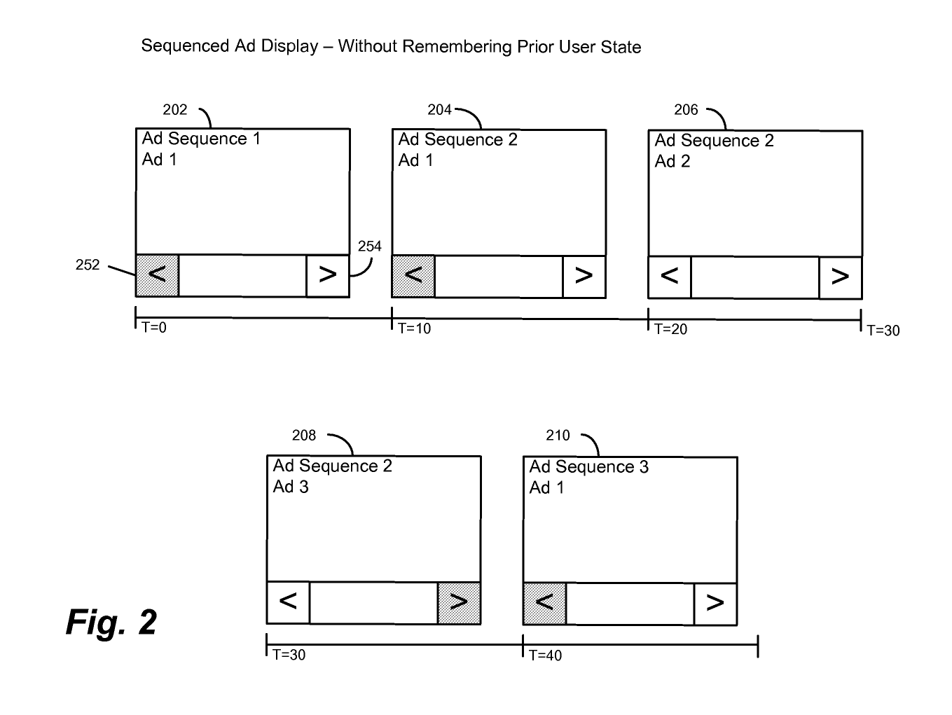

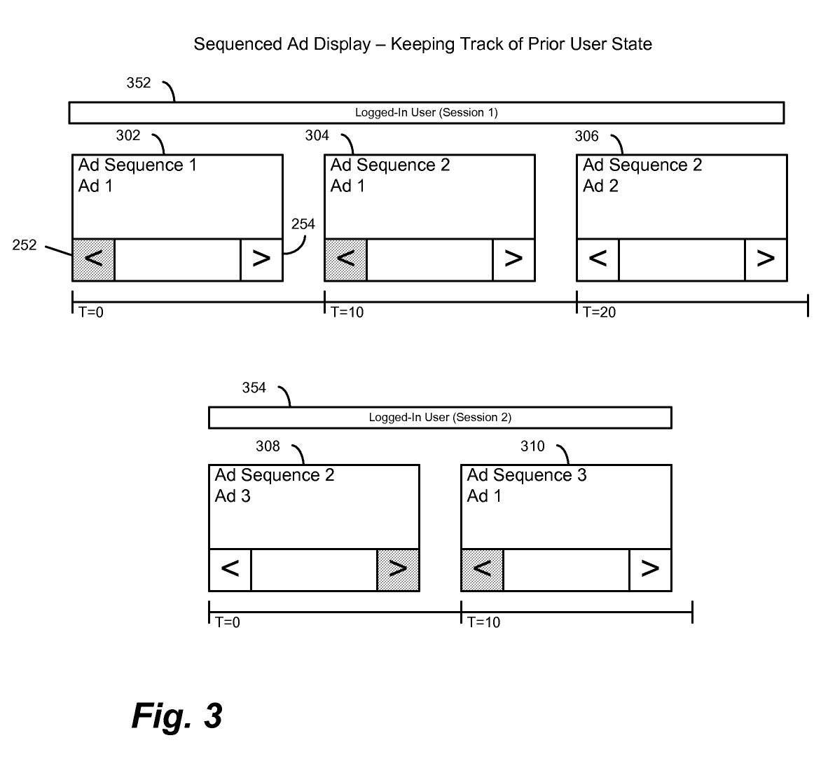

Having broadly described an example of a method in which an advertiser provides a sequence of advertisements for display to a user who is viewing web pages, we now provide some example screenshot timelines to illustrate some example scenarios. FIG. 2 schematically illustrates a timeline for example advertisement displays of various series, in which advertisement viewing state for a user is not persisted after a user exits the website/property of the publisher. FIG. 3 schematically illustrates a timeline for example advertisement displays of various series, in which advertisement viewing state for a user is persisted after a user exits the website/property of the publisher, such that the advertisement display appropriate to that state can be performed after the user re-enters the website/property of the publisher. In the timeline illustrations, the “T=” numbers are provided for easy reference only and are not intended to portray any particular determinative time frame.

Turning now to the FIG. 2 example timeline, at T=0 of the timeline, a first advertisement 202 of a first advertisement series may be displayed. For example, the advertisement may be a display advertisement displayed as a banner or in some other manner in association with display of a web page. In addition to displaying the advertisement, user interface elements are also displayed (in the FIG. 2 example, the use interface elements include a “previous” button 252 and a “next” button 254), to provide the user facility to provide an indication of how the user desires to interact with the series of advertisements. As shown in FIG. 2, for the first advertisement 202, the “previous” button 252 is disabled (i.e., the user cannot select to display a previous advertisement in the series), since there is no previous advertisement in the series to display. The “next” button 254 is enabled, however.

Assuming the user does not request, relative to the advertisement 204, to see the next advertisement in the sequence (i.e., the user does not select the “next” button 254) but, rather, for example, navigates to material other than to the next advertisement in the series, then the status of the series is “incomplete” and the Cost per Completion for the viewing of the series may be determined accordingly. Thus, referring still to FIG. 2, at T=10 of the timeline, a first advertisement 204 of a second advertisement sequence may be displayed. As just mentioned, in the FIG. 2 example, the Ad Sequence 1 was incomplete.

Since the advertisement 204 is the first advertisement of a sequence, as with the advertisement 202, the user interface elements are such that the “previous” button 252 is disabled and the “next” button 254 is enabled. At T=20, a second advertisement 206 of the second advertisement sequence is displayed, based on the user action of selecting the “next” button 254 relative to the first advertisement 204 of the second advertisement sequence. Now, with respect to the advertisement 206, the “previous” button 252 and the “next” button 254 are both enabled. In the FIG. 2 example, the second sequence has three advertisements, and if the user decides to exit the website/property without selecting to display the third advertisement in the second sequence, the status of the second sequence would be “partially complete,” with two advertisement impressions having been served for the second advertisement sequence.

However, referring still to FIG. 2, at T=30, the user has selected the “next” button 254 relative to the second advertisement 206 of the second sequence and so, a third advertisement 208 of the second sequence is displayed. The “next” button 254 relative to the third advertisement 208 is disabled, since there is no further advertisement of the second sequence to display. Since the second sequence has three advertisements total, and all three advertisements have been displayed, the status of the second sequence is indicated as “complete.” That is, the user is considered to have viewed the full sequence placed by the advertiser. Thus the publisher can generally command the highest premium (though, for example, additional activity with respect to the advertisements may contribute to a premium, such as purchasing an advertised product/service, causing the advertisement to be provided to another user such as by e-mail, etc.).

At T=40, there is another opportunity to display an advertisement to the user, such as navigation to another web page of the publisher's property. In some examples, the publisher may display an advertisement of a sequence that was previously only partially completed for that user (e.g., starting at the beginning of a sequence previously partially completed, at the advertisement that was being displayed when the user exited the partially-completed sequence, or at the advertisement in the sequence after the advertisement that was being displayed when the user exited the partially-completed sequence). In other examples, there may be a preference for avoiding advertisements of sequences that were previously only partially completed. In yet other examples, no preference is given for or against sequences that were previously only partially completed. In the FIG. 2 example, the advertisement displayed at T=40 is a first advertisement 210 of a third sequence. As with the display of other first advertisements of a sequence, the “previous” button 252 is disabled and the “next” button 254 is enabled.

We now turn to FIG. 3, which illustrates an example in which a user state, with respect to viewing displayed advertisement sequences, is persisted even after a user exits a website/property. Given the potential privacy implications, such state persistence may generally be done with appropriate notice/consent to the user. We first discuss a first session 352 (session 1) of a logged-in user with respect to the website/property of the publisher, which is followed by a second session 354 that begins after the user has exited (and re-entered) the website/property.

Still referring to FIG. 3, at T=0 of the FIG. 3 timeline, a first advertisement 302 of a first advertisement series may be displayed. As discussed above relative to FIG. 2, the first advertisement of a series may be displayed, for example, based on a combination of a user's demographic/behavioral/geo-location data. Since the first advertisement 302 is the first advertisement in a sequence, the “previous” button 252 is disabled and the “next” button 254 is enabled. At T=10, the user performs some action, not related to requesting to see the next advertisement in the sequence (such as not selecting the “next” button 254 and, for example, navigating to material other than to the next advertisement in the series), and the status of the series is indicated as “incomplete.”

Thus, at T=10 of the timeline (which is another opportunity to display an advertisement), an advertisement 304 of a second advertisement sequence may be displayed. Again, since the advertisement 304 is the first advertisement of a sequence, the “previous” button 252 is disabled and the “next” button 254 is enabled At T=20, a second advertisement 306 of the second advertisement sequence is displayed, based on the user action of selecting the “next” button 254 relative to the first advertisement 304 of the second advertisement sequence. Now, the “previous” button 252 and the “next” button 254 are both enabled. In the FIG. 3 illustration, the user decides to exit the website/property while the second advertisement 306 of the second advertisement sequence is displayed. This leaves the second sequence with the second advertisement 306 not acted upon. As a result, the third and final advertisement of the second advertisement sequence will not be requested at this time, and the status of the second advertisement sequence is indicated as “partially complete.”

At T=0 of the second user session 354, such as on the same or another day, the user logs into the website/property again. Since the user had left the second advertisement sequence, the advertisement presentation logic may be to redisplay the advertisement where the user left off (i.e., the second advertisement) or may be to display the next advertisement in the second advertisement sequence. In the FIG. 3 illustration, the third advertisement 308 in the second advertisement sequence is displayed. In this case, the “previous” button 252 is enabled but the “next” button 254 is disabled, since this is the final advertisement in the second advertisement sequence. The user has now seen all the advertisements in the second advertisement sequence and, so, the status of the second advertisement sequence is indicated as “complete.” Finally, at T=10 of the second user session 354, the user is presented with a new advertisement sequence, such that the first advertisement 310 of the third advertisement sequence is displayed.

We have thus described examples of a system and/or method in which an advertiser provides a sequence of advertisements for display to a user, such as to a user who is viewing web pages. Subsequent advertisement in the sequence may be displayed based on a demonstrated user intent to view the subsequent advertisements, while the user is viewing advertisements of the series. A cost per completion amount (which may roughly correspond to an amount of revenue that the publisher may garner based on publishing of the advertisements) may be based on an amount of progression of the user within the series of advertisements.

It is noted that the type (format) of ad displayed in the sequence or series can be of any format—standard text, display, rich media, smart ads or video. Additionally, the sequence can be made up of either advertisements that are all the same type or format, or the sequence can be made up of advertisements that have various formats, within the sequence. This medium of ads is may be optimized if the advertisement type is either rich media/smart ads or video based. Regardless of the advertisement format used, sequential advertisements contribute to “persistent” messaging—as the users are exposed to consistent and persistent messaging from the same advertiser over the same or multiple sessions, as described above.

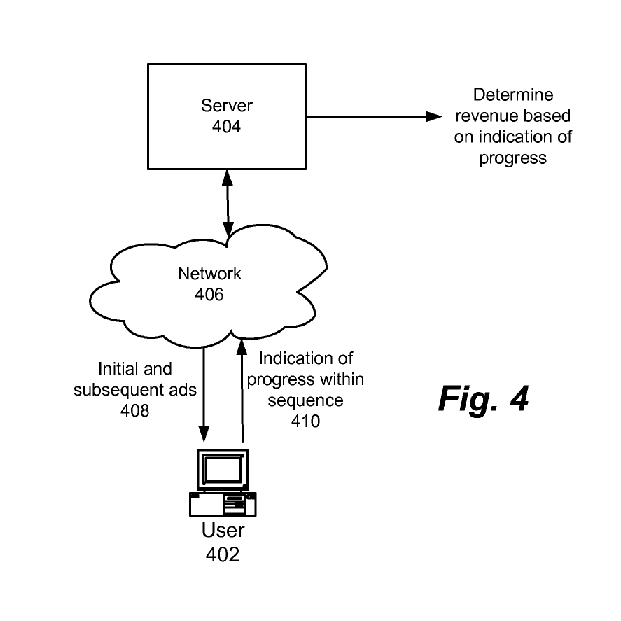

FIG. 4 schematically illustrates an example of a system in which the described method may be provided. Referring to FIG. 4, a user 402 (e.g., using a browser program of a client computer) may request a server computer 404 to provide a web page to the user 402 via a network 406 such as the internet. Initial and subsequent advertisements of a sequence 408 are provided to the user 402 via the network 406. An indication of progress within a sequence 410 is provided from the user 402 via the network 406 and/or in some examples, tracking of progress is performed at the server 404 (or another server) based on observation of requests for subsequent advertisements of a sequence. Revenue (i.e., cost for completion) for a sequence is determined based on the indication of progress within the sequence.

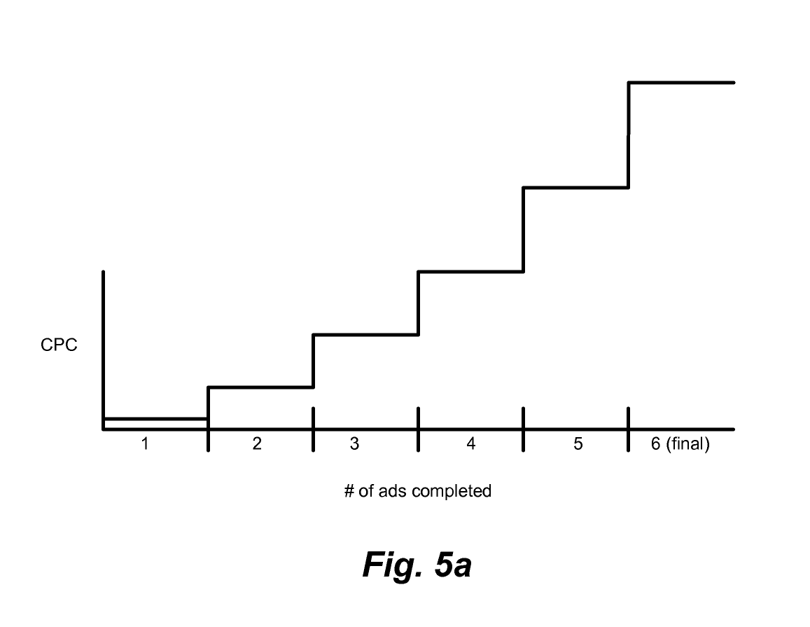

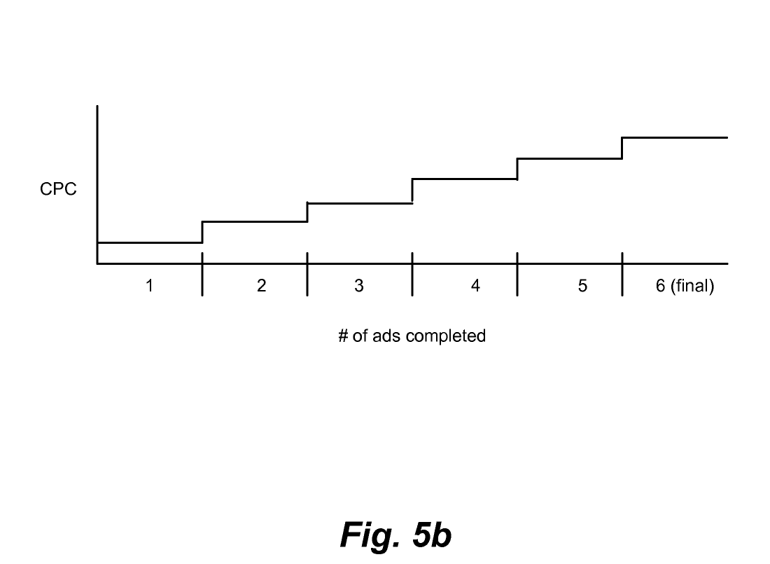

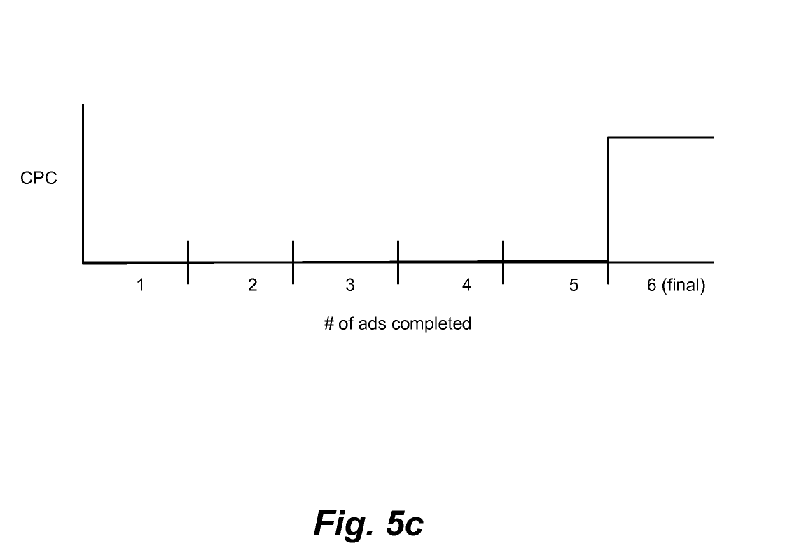

FIGS. 5a, 5b and 5c illustrate some examples of how the cost per completion (CPC) may be determined for a sequence. Each figure represents a sequence of six advertisements. In FIG. 5a, the CPC is shown as an exponential function of the number of advertisements of a sequence completed. In FIG. 5a, the CPC is shown as an exponential function of the number of advertisements of a series completed. In FIG. 5b, the CPC is shown as a linear function of the number of advertisements of a series completed. Finally, in FIG. 5c, the CPC is shown as an “all or nothing” function of the number of advertisements of a series completed. These are examples, and other examples are possible as well.

It should also be noted that sequenced ads can be scheduled in a way that no user action is required. In this case, for example, a user may see all advertisements for “sequence 1,” then all advertisements for “sequence 2” and so on without any intervention. This model may not command the same high level of premium (cost per completion) as sequences of advertisements that are advanced according to user intervention since a demonstration of user's intent to view additional advertisements in a sequence is implied rather than explicit.

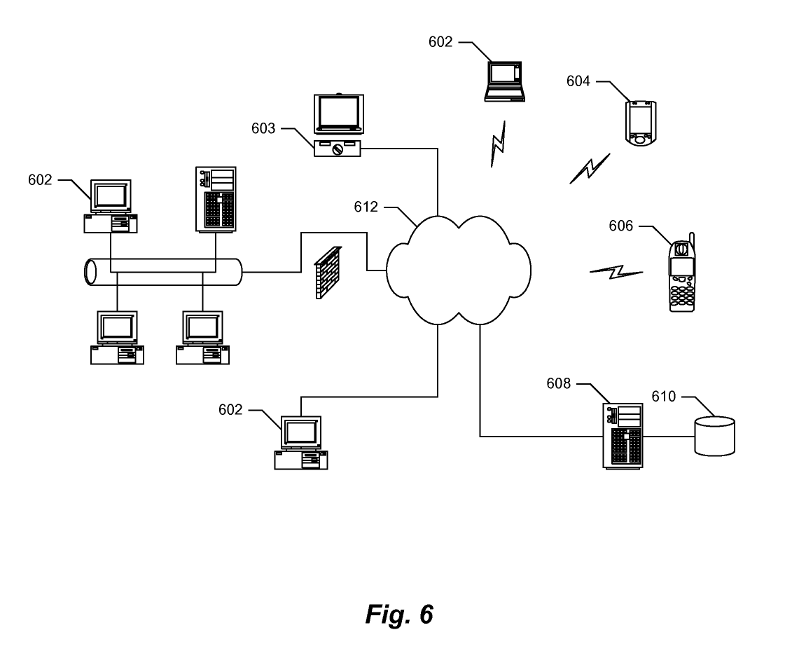

Embodiments of the present invention may be employed to display advertisements and determine cost per completion of advertisement sequences in any of a wide variety of computing contexts. For example, as illustrated in FIG. 6, implementations are contemplated in which users may interact with a diverse network environment via any type of computer (e.g., desktop, laptop, tablet, etc.) 602, media computing platforms 603 (e.g., cable and satellite set top boxes and digital video recorders), handheld computing devices (e.g., PDAs) 604, cell phones 606, or any other type of computing or communication platform.

According to various embodiments, applications may be executed locally, remotely or a combination of both. The remote aspect is illustrated in FIG. 6 by server 608 and data store 610 which, as will be understood, may correspond to multiple distributed devices and data stores.

The various aspects of the invention may also be practiced in a wide variety of network environments (represented by network 612) including, for example, TCP/IP-based networks, telecommunications networks, wireless networks, etc. In addition, the computer program instructions with which embodiments of the invention are implemented may be stored in any type of computer-readable media, and may be executed according to a variety of computing models including, for example, on a stand-alone computing device, or according to a distributed computing model in which various of the functionalities described herein may be effected or employed at different locations.

What is claimed is:

1. A method of providing advertising, comprising:
providing an initial advertisement to a user, where the initial advertisement is a first advertisement of a series of related advertisements from a same advertiser;
providing subsequent advertisements of the series to the user based on a demonstrated intent from the user to view the subsequent advertisements while the user is viewing advertisements of the series; and
determining a cost per completion amount based on the progression of the user within the series of advertisements.

2. The method of claim 2, wherein:
providing the initial advertisement to the user and providing subsequent advertisements to the user is in conjunction with causing at least one web page to be displayed to the user.

3. The method of claim 1, wherein:
determining a cost per completion amount is according to a predetermined function of the progress of the user within the series of advertisements.

4. The method of claim 1, wherein:
providing the initial advertisement to the user is not based on a demonstrated intent by the user to view the particular initial advertisement.

5. The method of claim 1, wherein:
the series is a first series; and
the method further comprises, based on an indication of lack of the demonstrated intent from the user to view subsequent advertisements while the user is viewing advertisements of the first series, providing a second initial advertisement to a user, where the second initial advertisement is a first advertisement of a second series of related advertisements from a same advertiser.

6. The method of claim 5, wherein:
the indication of lack of demonstrated intent from the user includes surfing away from a web page in conjunction with which the advertisement of the first series has been provided.

7. The method of claim 1, wherein:
maintaining an indication of a state of the series with respect to the user, wherein the indication of the state of the series indicates what particular advertisement of the series is being viewed; and
after an indication of lack of demonstrated intent from the user to view subsequent advertisements while the user is viewing advertisements of the series, returning to the state of the series with respect to the user, indicated by the state indication, to display the particular advertisement or a subsequent advertisement of the series.

8. The method of claim 7, wherein:
the indication of lack of demonstrated intent from the user to view subsequent advertisements while the user is viewing advertisements of the series includes the user surfing away from a web page of a web property in conjunction with which the advertisement of the first series has been provided; and
returning to the state of the series with respect to the user, indicated by the state indication, is based on returning to a web page of the web property.

9. The method of claim 7, wherein:
the indication of the state of the series is preserved even if the user leaves the web property.

10. A system configured to display advertisements in conjunction with published content, comprising:
a server configured to:
provide a plurality of advertisements for display on a client device; and
receive from a client device an indication of progression of a user of the client device within a series of advertisements, wherein the series of advertisements are advertisements of the plurality of advertisements, the progression of the user being in response to a demonstrated intent from the user relative to the client device to view subsequent advertisements of the series displayed by the client device while the user is viewing advertisements of the series displayed by the client device; and
determine a cost per completion amount based on the received indication of progression of the user of the client device within the series of advertisements.

11. The method of claim 10, wherein:
the server being configured to provide the plurality of advertisements includes the server being configured to provide the plurality of advertisements in conjunction with web pages to be displayed by the client device to the user.

12. The method of claim 10, wherein:
determining a cost per completion amount is according to a predetermined function of the progress of the user within the series of advertisements.

13. The method of claim 10, wherein:
providing the initial advertisement to the client device for display to the user is not based on a demonstrated intent by the user to view the particular initial advertisement.

14. The method of claim 10, wherein:
the series is a first series; and
the server is further configured to, based on an indication of lack of the demonstrated intent from the user to view subsequent advertisements while the user is viewing advertisements of the first series, provide a second initial advertisement to a user, where the second initial advertisement is a first advertisement of a second series of related advertisements from a same advertiser.

15. The method of claim 14, wherein:
the indication of lack of demonstrated intent from the user includes surfing away from a web page in conjunction with which the advertisement of the first series has been provided.

16. The method of claim 10, wherein the server is further configured to:
maintain an indication of a state of the series with respect to the user, wherein the indication of the state of the series indicates what particular advertisement of the series is being viewed; and
after an indication of lack of demonstrated intent from the user to view subsequent advertisements while the user is viewing advertisements of the series, return to the state of the series with respect to the user, indicated by the state indication, to display the particular advertisement or a subsequent advertisement of the series.

17. The method of claim 16, wherein:
the indication of lack of demonstrated intent from the user to view subsequent advertisements while the user is viewing advertisements of the series includes the user surfing away from a web page of a web property in conjunction with which the advertisement of the first series has been provided; and
returning to the state of the series with respect to the user, indicated by the state indication, is based on returning to a web page of the web property.

18. The method of claim 16, wherein:
the indication of the state of the series is preserved even if the user leaves the web property.

19. A system to provide advertising, comprising:
a server configured to provide, via a network, an initial advertisement to a client device to be displayed to a user, where the initial advertisement is a first advertisement of a series of related advertisements from a same advertiser;
the client device, configured to receive an indication of a demonstrated intent from the user to view subsequent advertisements while the user is viewing advertisements of the series;
the server further configured to
provide the subsequent advertisements of the series to the user based on a demonstrated intent from the user to; and
determine a cost per completion amount based on the progression of the user within the series of advertisements.
